(19) United States
(12) Patent Application Publication
(10) Pub. No.: US 2004/0241434 A1
(43) Pub. Date: Dec. 2, 2004

(54) Pressure-sensitive adhesive double-coated sheet

(76) Inventors: Tomoo Yamaguchi, Osaka (JP); Masayuki Ishikawa, Osaka (JP); Kenji Kaneko, Osaka (JP); Kazumasa Asano, Osaka (JP); Yasunobu Ina, Osaka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/452,700

(22) Filed: Jun. 2, 2003

(51) Int. Cl. B32B 7/12

(52) U.S. Cl. 428/354; 428/356

(57) ABSTRACT

A pressure-sensitive adhesive double-coated sheet comprising a substrate, a pressure-sensitive adhesive layer (A) formed on one side of the substrate and a pressure-sensitive adhesive layer (B) formed on the other side of the substrate, wherein at least the pressure-sensitive adhesive layer (A) is formed with a pressure-sensitive adhesive comprising a butyl rubber as base material, and after the pressure-sensitive adhesive double-coated sheet is allowed to stand at 60° C. for five days while being placed between a moisture vapor-permeable waterproof sheet attached to the adhesive layer (A) and an aluminum plate attached to the adhesive layer (B), an expansion coefficient of the moisture vapor-permeable waterproof sheet is 0.5% or less. The pressure-sensitive adhesive double-coated sheet can allow the moisture vapor-permeable waterproof sheet to less expand over time when attached between the moisture vapor-permeable waterproof sheet and the adherend in a waterproof airtight structure of a construction.

### BACKGROUND OF THE INVENTION

1. Field of the Invention

The present invention relates to a pressure-sensitive adhesive double-coated sheet. Typically, the pressure-sensitive adhesive double-coated sheet of this invention can be used as a waterproof airtight material to make moisture vapor-permeable waterproof sheets adhere to a variety of house building materials or the like in a construction work for forming waterproof airtight structures.

2. Description of the Related Art

The Japanese Housing Quality Assurance Law requires completely water-leak proof housing construction. Thus, a variety of waterproof sheets are used in a construction work for forming waterproof airtight structures. In recent years, high-airtightness, high-insulation housing, which can more efficiently save the energy, has become in demand, and therefore a variety of airtight sheets have been used.

In the process of forming the waterproof airtight structure, pressure-sensitive adhesive sheets are used, and known pressure-sensitive adhesives for such sheets include rubber asphalt, butyl rubber, or acrylic polymer as base materials. Particularly, the butyl rubber pressure-sensitive adhesive has a track record of 30-year endurance and shows relatively good adhesive properties at high and low temperatures. The butyl rubber pressure-sensitive adhesive also has an excellent waterproof performance and shows cohesion failure mode when peeled from the adherend in the test for the waterproof performance. If such cohesion failure is not shown, a gap can be formed between the adherend and the pressure-sensitive adhesive. Water would intrude into such a gap so that waterproofness cannot be achieved undesirably. The rubber asphalt pressure-sensitive adhesive has a short endurance time of about 10 years and has poor adhesive properties at high and low temperatures. The acrylic pressure-sensitive adhesive, which has become commercially available in recent years, does not show cohesion failure mode when peeled from the adherend and is not sure to provide sufficient waterproof performance for a long time.

In the above-mentioned properties, the butyl rubber pressure-sensitive adhesive is superior to other waterproofing airtight pressure-sensitive adhesives. Thus, the butyl rubber-based pressure-sensitive adhesive has been used for waterproof airtight pressure-sensitive adhesive sheets. In addition, such a pressure-sensitive adhesive has been used in the form of a solid composition. Such a solid type pressure-sensitive adhesive composition is a solvent-free, nonaqueous composition, which is free of an environmental pollution-causing organic solvent and free of water that would otherwise need large amount of drying energy. The solid type pressure-sensitive adhesive composition is generally in a solid state at room temperature and generally prepared by the steps of mixing a gum polymer such as natural rubber as a main component and a tackifier, and usually a filler such as calcium carbonate fine powder, a softener such as oil, an antioxidant, and the like in an appropriate ratio and kneading the mixture in a kneader, a Banbury mixer, a mixing roll, or the like while heating.

In recent years, the waterproof airtight pressure-sensitive adhesive sheets have been desired to be able to adhere to any new type of housing material or a variety of adherend materials including wooden boards, plywood boards, and moisture vapor-permeable waterproof sheets for long-time sustained waterproofness and airtightness. Therefore, the butyl rubber pressure-sensitive adhesive has also been desired to further improve in performance.

For example, in the case that the solid type of butyl rubber pressure-sensitive adhesive is applied to the moisture vapor-permeable waterproof sheet, the sheet can expand to form ridges and grooves, which can be a water passage to degrade the waterproofness. In another case, the solid type of butyl rubber pressure-sensitive adhesive can be poor in cohesion at high temperature and can allow the attached position to shift from the original position over time.

It is an object of this invention to provide a pressure-sensitive adhesive double-coated sheet that comprises at least one butyl rubber-based pressure-sensitive adhesive layer and can allow the moisture vapor-permeable waterproof sheet to less expand over time when attached between the moisture vapor-permeable waterproof sheet and the adherend in a waterproof airtight structure of a construction.

It is another object of this invention to provide a pressure-sensitive adhesive double-coated sheet that can suppress the expansion of the moisture vapor-permeable waterproof sheet over time and can have good adhesion to a variety of building adherend.

### SUMMARY OF THE INVENTION

For the purpose of solving the above problems, the inventors have been made thorough investigations on pressure-sensitive adhesives for forming the adhesive layer of the pressure-sensitive adhesive double-coated sheet. As a result, the inventors have found that the pressure-sensitive adhesive double-coated sheet as described below can fulfill the above objects in the completion of the present invention.

This invention is therefore directed to a pressure-sensitive adhesive double-coated sheet comprising a substrate, a pressure-sensitive adhesive layer (A) formed on one side of the substrate and a pressure-sensitive adhesive layer (B) formed on the other side of the substrate,

wherein at least the pressure-sensitive adhesive layer (A) is formed with a pressure-sensitive adhesive comprising a butyl rubber as base material,

and after the pressure-sensitive adhesive double-coated sheet is allowed to stand at 60° C. for five days while being placed between a moisture vapor-permeable waterproof sheet attached to the adhesive layer (A) and an aluminum plate attached to the adhesive layer (B), an expansion coefficient of the moisture vapor-permeable waterproof sheet is 0.5% or less.

According to this invention, the pressure-sensitive adhesive double-coated sheet provides an expansion coefficient of 0.5% or less for the moisture vapor-permeable waterproof sheet after the above-defined test. According to this invention, the moisture vapor-permeable waterproof sheet can less expand over time where attached to the adherend via the inventive pressure-sensitive adhesive sheet in a waterproof airtight structure of a construction. In this invention, the expansion coefficient is preferably as small as possible and preferably 0.4% or less, most preferably 0%. The expansion coefficient can be determined by the method as described in detail in the Example section below.

In another aspect, this invention is directed to a pressure-sensitive adhesive double-coated sheet comprising a substrate, a pressure-sensitive adhesive layer (A) formed on one side of the substrate and a pressure-sensitive adhesive layer (B) formed on the other side of the substrate,

wherein at least the pressure-sensitive adhesive layer (A) is formed with a pressure-sensitive adhesive comprising a butyl rubber as base material and a softener, which has a weight, average molecular weight of 1000 or more.

In terms of adhesion properties, general solid type butyl rubber-based pressure-sensitive adhesives contain a low molecular-weight oil component as a softener. Such an oil component is nonpolar and has good compatibility with the moisture vapor-permeable waterproof sheet material such as polyethylene, which is also nonpolar. Therefore, if the pressure-sensitive adhesive sheet with such a butyl rubber adhesive layer is attached to the moisture vapor-permeable waterproof sheet, the oil component should penetrate from the adhesive layer to the moisture vapor-permeable waterproof sheet to make the waterproof sheet expand. The oil component has a lower molecular weight than other components and therefore tends to move to the adhesive surface. Such a tendency should also contribute to the expansion of the moisture vapor-permeable waterproof sheet. In contrast, the pressure-sensitive adhesive double-coated sheet of this invention comprises a softener with a weight average molecular weight of 1000 or more in the pressure-sensitive adhesive layer (A), which gives an adhesive surface to the moisture vapor-permeable waterproof sheet. Therefore, the penetration or the shift of the softener into the moisture vapor-permeable waterproof sheet can be suppressed. Thus, the pressure-sensitive adhesive sheet of this invention can suppress the expansion of the moisture vapor-permeable waterproof sheet over time when attached between the waterproof sheet and the adherend in a waterproof airtight structure of a construction.

In the pressure-sensitive adhesive double-coated sheet, the pressure-sensitive adhesive layer (B) preferably comprises an adhesive crosslinked with a crosslinking agent.

Into the pressure-sensitive adhesive layer (B) on the opposite side of the pressure-sensitive adhesive layer (A) giving an adhesive surface to the moisture vapor-permeable waterproof sheet of the pressure-sensitive adhesive double-coated sheet, such crosslinking may also be introduced so that the expansion of the moisture vapor-permeable waterproof sheet can further be suppressed. The pressure-sensitive adhesive layer (B) may give an adhesive surface to a rough surface of the building material such as a wooden board and a plywood board. In such a case, the crosslinking treatment can improve the cohesion strength at high temperature and produce strong adhesion to the rough surface.

In the pressure-sensitive adhesive double-coated sheet, the substrate preferably comprises at least one layer of plastic film.

### DETAILED DESCRIPTION OF THE PREFERRED EMBODIMENTS

In the pressure-sensitive adhesive double-coated sheet of the present invention, the adhesive layer (A) is formed with a pressure-sensitive adhesive comprising a butyl rubber as base material. Any type of butyl rubber may be used without limitation, and any of synthetic butyl rubber and reclaimed butyl rubber may be used. Particularly, the synthetic butyl rubber is preferably used in terms of suppression of the expansion of the moisture vapor-permeable waterproof sheet, durability, or weatherability.

A softener is contained in the pressure-sensitive adhesive for the adhesive layer (A) with the butyl rubber, a base material. The softener has a weight average molecular weight of 1000 or more. The softener for suppressing the expansion of the moisture vapor-permeable waterproof sheet preferably has a weight average molecular weight of 2000 or more. The softener has no particular upper limit of the weight average molecular weight but may have a weight average molecular weight of up to about 100000. Examples of the softener include process oil, polybutene, and a liquid tackifier, and one of these materials may be used, or two or more thereof may be used in combination. The softener may be contained in an amount of 5 to 150 parts by weight, preferably 10 to 100 parts by weight, based on 100 parts by weight of the butyl rubber.

Generally, any tackifier is further contained in the pressure-sensitive adhesive for the adhesive layer (A). The tackifier is used to provide stickiness and heat softening tendency. Preferred examples of the tackifier include a variety of resins compatible with the butyl rubber. Such examples include petroleum resins, phenolic resins, rosin resins, terpene resins, and hydrogenated materials thereof. One of these tackifiers may be used, or two or more thereof may be used in combination. In particular, the hydrogenated terpene resin is preferably used to suppress the expansion of the moisture vapor-permeable waterproof sheet. The tackifier is preferably contained in an amount of 20 to 200 parts by weight, more preferably 30 to 150 parts by weight, based on 100 parts by weight of the butyl rubber.

In the pressure-sensitive adhesive double-coated sheet of this invention, any pressure-sensitive adhesive may be used without limitation to form the adhesive layer (B). If the pressure-sensitive adhesive double-coated sheet is used for a waterproof airtight material, the adhesive layer (B) gives an adhesive surface to the house building material or the like. Therefore, the pressure-sensitive adhesive for the adhesive layer (B) preferably comprises an adhesive composition that has strong adhesion to rough surface adherend materials.

Examples of the applicable pressure-sensitive adhesive forming the adhesive layer (B) include conventional pressure-sensitive adhesives such as rubber asphalt, butyl rubber, or acrylic polymer, as base materials. The butyl rubber-based pressure-sensitive adhesive is particularly preferred.

Any type of butyl rubber may be used without limitation for the adhesive layer (B), and any of synthetic butyl rubber and reclaimed butyl rubber may be used. In particular, such butyl rubber preferably differs from the butyl rubber for the adhesive layer (A). Specifically, the reclaimed butyl rubber is preferably used in terms of adhesion to rough surface adherend materials, durability, or weatherability.

A softener is contained in the butyl rubber pressure-sensitive adhesive for the adhesive layer (B). Examples of the softener include a variety of materials compatible with the butyl rubber, such as process oil, polybutene, and a liquid tackifying component, and one of these materials may be used, or two or more thereof may be used in combination. The softener may have any weight average molecular weight. However, a low molecular weight can cause the shift of the softener into the moisture vapor-permeable waterproof sheet or cause a significant reduction in cohesive strength at high temperature. Therefore, similarly to the case of the butyl rubber pressure-sensitive adhesive for the adhesive layer (A), the softener preferably has a weight average molecular weight of 1000 or more, more preferably 2000 or more. The softener has no particular upper limit of the weight average molecular weight but may have a weight average molecular weight of up to about 100000. The softener may be contained in an amount of 5 to 150 parts by weight, preferably 10 to 100 parts by weight, based on 100 parts by weight of the butyl rubber.

Generally, any tackifier is further contained in the butyl rubber pressure-sensitive adhesive for the adhesive layer (B). Preferred examples of the tackifier include a variety of resins compatible with the butyl rubber. Such examples include petroleum resins, phenolic resins, rosin resins, terpene resins, and hydrogenated materials thereof. One of these tackifiers may be used, or two or more thereof may be used in combination. In particular, the hydrogenated terpene resin is preferably used to suppress the expansion of the moisture vapor-permeable waterproof sheet. The tackifier is preferably contained in an amount of 20 to 200 parts by weight, more preferably 30 to 150 parts by weight, based on 100 parts by weight of the butyl rubber.

Any crosslinking agent may be added to the pressure-sensitive adhesive for the adhesive layer (B) depending on the type of the base material. Examples of the crosslinking agent for treating the butyl rubber pressure-sensitive adhesive include a thiuram vulcanizing agent, a quinoid vulcanizing agent, a quinonedioxime vulcanizing agent, and a maleimide vulcanizing agent. One of these crosslinking agents may be used, or two or more thereof may be used in combination. Examples of the thiuram vulcanizing agent include tetramethylthiuram disulfide, tetraethylthiuram disulfide, tetrabutylthiuram disulfide, tetrakis(2-ethylhexyl)thiuram disulfide, dipentamethylenethiuram tetrasulfide, and tetramethylthiuram monosulfide. Examples of the quinoid vulcanizing agent include poly-p-dinitrosobenzene. Examples of the quinonedioxime vulcanizing agent include p-quinonedioxime and p,p′-dibenzoylquinonedioxime. Examples of the maleimide vulcanizing agent include N,N′-m-phenylenedimaleimide, N,N′-p-phenylenedimaleimide, and N,N′-ethylenedimaleimide. These crosslinking agents are all characterized in that they can produce crosslinking at low temperature (for example, a temperature of 180° C. or lower) at high rate. The crosslinking agent is generally added in an amount of 20 parts by weight or less, preferably 0.5 to 20 parts by weight, more preferably 0.5 to 10 parts by weight, based on 100 parts by weight of the butyl rubber for the adhesive layer (B).

Additionally, the butyl rubber pressure-sensitive adhesive for the adhesive layer (A) or the pressure-sensitive adhesive for the adhesive layer (B) may contain a filler such as calcium carbonate, talc, and magnesium oxide, an antioxidant, a plasticizer, or the like. Based on 100 parts by weight of the butyl rubber (base), the filler may be contained in an amount of 200 parts by weight or less, preferably 10 to 150 parts by weight, and the antioxidant may be contained in an amount of 5 parts by weight or less, preferably 0.5 to 5 parts by weight, more preferably 1 to 3 parts by weight.

In this invention, the pressure-sensitive adhesive may be prepared in the form of a solid pressure-sensitive adhesive composition. The pressure-sensitive adhesive composition may be prepared by any process without limitation, for example, by the steps of appropriately adding the above additive to the mixture of the butyl rubber (base material), the softener, and the tackifier, then optionally adding the crosslinking agent to the mixture in the case that the composition to be prepared should have strong adhesion to a rough surface, and then heating and kneading the resulting mixture without using any organic solvent or water. The step of heating and kneading may be carried out using a batch kneader such as a pressure kneader, a Banbury mixer, and a mixing roll or a continuous kneader such as a biaxial kneader. The solid type pressure-sensitive adhesive composition resulting from the step of heating and kneading can easily be softened by heating and well shaped into a desired form.

The pressure-sensitive adhesive double-coated sheet may be produced by the steps of heating the pressure-sensitive adhesive composition and applying it to a substrate using a calender roll, an extruder, or the like to form adhesive layers each comprising the above-mentioned pressure-sensitive adhesive composition. This process needs neither organic solvent that would otherwise cause environmental pollution nor water that would otherwise need large amount of drying energy. Therefore, this process can be free from the step of heating the pressure-sensitive adhesive composition on the substrate in a drying oven after the applying step, be environmentally friendly, and significantly contribute to energy saving.

The adhesive layers (A) and (B) each comprising the above-mentioned pressure-sensitive adhesive composition may each have a thickness (adhesive thickness) in a wide range of generally from about 50 to about 500 μm, preferably from 100 to 300 μm. Within such a range, even a small adhesive thickness can be free from a significant reduction in stickiness, and therefore, the adhesive layer with such a small thickness can be formed of a minimum required amount of the pressure-sensitive adhesive composition.

The substrate may be made of any type of material. Examples of the substrate material include fabrics (such as cotton fabric, staple fiber fabric, chemical fiber fabric, and non-woven fabric), papers (such as Japanese paper and kraft paper), plastics (such as cellophane, polyethylene, polyvinyl chloride, acetyl cellulose, polypropylene, polyethylene terephthalate, polystyrene, and polyacrylonitrile), metal foils, and plastic laminates thereof.

In the case that the adhesive layers (A) and (B) are formed of different pressure-sensitive adhesive compositions, the substrate preferably comprises at least one layer of plastic film so as to prevent the shift of the component, particularly the softener. For example, the non-woven fabric or the like is preferably laminated with a plastic film into a plastic film laminate substrate.

In order to have an improved adhesive force (anchoring force) to the pressure-sensitive adhesive layer, the substrate may be subjected to any known treatment such as surface treatment of the adhesive applying surface of the substrate by corona treatment, plasma treatment, or the like, or a process of applying a primer layer.

Each pressure-sensitive adhesive layer of the resulting pressure-sensitive adhesive double-coated sheet may be covered with a release paper. The pressure-sensitive adhesive double-coated sheet may also be wound into a roll with a release paper inserted so that it can be easily released.

The pressure-sensitive adhesive double-coated sheet of this invention can suppress the expansion of the moisture vapor-permeable waterproof sheet attached thereto. It can also prevent the attached moisture vapor-permeable waterproof sheet from forming ridges and grooves and ensure the waterproof performance for a long time. If both pressure-sensitive adhesive layers are different in adhesive composition, the pressure-sensitive adhesive double-coated sheet can have good adhesion to rough surface adherends such as building materials at low and high temperatures and can maintain high holding property when allowed to stand at high temperature. Therefore, the pressure-sensitive adhesive double-coated sheet of this invention is applicable in bonding the moisture vapor-permeable waterproof sheet and useful as a waterproof tape or an airtight tape for a waterproof airtight structure of housing in terms of its high waterproofness, durability, and weatherability. In addition, it may be widely used in waterproof building applications other than housing.

### EXAMPLES

This invention is described below in more detail by showing examples, but such examples are not intended to limit the scope of this invention.

### Example 1

(A First Example of the Preparation of the Pressure-Sensitive Adhesive Composition)

To a 5-L kneader heated at 120° C. were added 1000 g of butyl rubber (with a Mooney viscosity ML1+4 (at 100° C.) of 40±5) and 2000 g of calcium carbonate powder and kneaded for about 5 minutes. Thereto was added 500 g of a petroleum resin (Escorez® 1202 (Exxon)) as a tackifier and kneaded for about 10 minutes. Additionally, 700 g of a softener (Polybutene HV300 (Nippon Petrochemicals) with a weight average molecular weight of 3000) and 750 g of another softener (TETRAX 5T (Nippon Petrochemicals) with a weight average molecular weight of 50000) were each added in several parts and kneaded for about 10 minutes. The resulting preparation was then taken out from the kneader to give a pressure-sensitive adhesive composition (a).

(A Second Example of the Preparation of the Pressure-Sensitive Adhesive Composition)

To a 5-L kneader heated at 120° C. were added 1000 g of reclaimed butyl rubber (with a Mooney viscosity ML1+4 (at 100° C.) of 44±6) and 2000 g of calcium carbonate powder and kneaded for about 5 minutes. Thereto was added 500 g of a petroleum resin (Escorez® 1202 (Exxon)) as a tackifier and kneaded for about 10 minutes. Additionally, 1000 g of a softener (Polybutene HV300 (Nippon Petrochemicals)) was added in several parts and kneaded for about 10 minutes. Finally, 20 g of a quinoid crosslinking agent (VULNOC DNB (OUCHISHINKO CHEMICAL INDUSTRIAL)) was added and kneaded for about 5 minutes to form crosslinking. The resulting preparation was then taken out from the kneader to give a pressure-sensitive adhesive composition (b).

(Production of the Pressure-Sensitive Adhesive Double-Coated Sheet)

Onto a substrate (a polyethylene terephthalate film with a thickness of 0.025 mm), the pressure-sensitive adhesive composition (a) heated at 80° C. was applied with an adhesive thickness of 0.15 mm using an 8-inch four-roll calender to form a pressure-sensitive adhesive layer (A). The pressure-sensitive adhesive composition (b) was then heated at 80° C. and applied with an adhesive thickness of 0.2 mm to form a pressure-sensitive adhesive layer (B), resulting in a pressure-sensitive adhesive double-coated sheet.

### Example 2

The process of Example 1 was used to form a pressure-sensitive adhesive double-coated sheet except that the substrate was a non-woven fabric laminated with 0.12-mm thick polyethylene terephthalate.

### Example 3

(Preparation of the Pressure-Sensitive Adhesive Composition)

To a 5-L kneader heated at 120° C. were added 1000 g of reclaimed butyl rubber (with a Mooney viscosity ML1+4 (at 100° C.) of 44±6) and 1500 g of calcium carbonate powder and kneaded for about 5 minutes. Thereto was added 500 g of a petroleum resin (Escorez® 1202 (Exxon)) as a tackifier and kneaded for about 10 minutes. Additionally, 100 g of a softener (Polybutene HV300 (Nippon Petrochemicals)) and 300 g of another softener (Process Oil PW90 (Idemitsu Kosan) with a weight average molecular weight of 500) were each added in several parts and kneaded for about 10 minutes. Finally, 20 g of a quinoid crosslinking agent (VULNOC DNB (OUCHISHINKO CHEMICAL INDUSTRIAL)) was added and kneaded for about 5 minutes to form crosslinking. The resulting preparation was then taken out from the kneader to give a pressure-sensitive adhesive composition (c).

(Production of the Pressure-Sensitive Adhesive Double-Coated Sheet)

The process of Example 1 was used to form a pressure-sensitive adhesive double-coated sheet except that the pressure-sensitive adhesive composition (c) was used to form the adhesive layer (B) in place of the pressure-sensitive adhesive composition (b).

### Example 4

The process of Example 1 was used to form a pressure-sensitive adhesive double-coated sheet except that the pressure-sensitive adhesive composition (a) was used to form both of the adhesive layers (A) and (B).

### Example 5

(Preparation of the Pressure-Sensitive Adhesive Composition)

Except that no crosslinking agent was used, the second adhesive composition process of Example 1 was used to form a pressure-sensitive adhesive composition (d). The process of Example 1 was also used to form a pressure-sensitive adhesive double-coated sheet except that the pressure-sensitive adhesive composition (d) was used to form the adhesive layer (B) in place of the pressure-sensitive adhesive composition (b).

### Comparative Example 1

The process of Example 1 was used to form a pressure-sensitive adhesive double-coated sheet except that the pressure-sensitive adhesive composition (c) prepared in Example 3 was used to form both of the adhesive layers (A) and (B).

### Comparative Example 2

The process of Example 3 was used to form a pressure-sensitive adhesive double-coated sheet except that the substrate was a non-laminated, non-woven fabric.

The pressure-sensitive adhesive double-coated sheets prepared in Examples 1 to 5 and Comparative Examples 1 and 2 were each measured for expansion coefficient, adhesion strength, and holding power according to the methods below. The results of the tests are shown in Table 1.

Expansion Coefficient of Moisture Vapor-Permeable Waterproof Sheet

The expansion coefficient of the moisture vapor-permeable waterproof sheet was determined as follows: The pressure-sensitive adhesive double-coated sheet (50 mm in width and 100 mm in length) was sandwiched between a moisture vapor-permeable waterproof sheet (Tyvek® 1060B (DuPont-Asahi) 0.18 mm in thickness, 100 mm in width, and 100 mm in length) and an aluminum plate (2 mm in thickness), wherein the adhesive layer (A) was attached to the moisture vapor-permeable waterproof sheet, and the adhesive layer (B) was attached to the aluminum plate, and then allowed to stand in the atmosphere at 60° C. for 5 days, and then the length of the expanded moisture vapor-permeable waterproof sheet was determined to produce the expansion coefficient as an extension percentage with respect to the 100-mm original length according to the formula below.

Expansion Coefficient=[((Length after Expansion)−(Original Length))/(Original Length)]×100(%)

Adhesion Test

The adhesive layer (A) of the pressure-sensitive adhesive double-coated sheet with a width of 25 mm was attached to the moisture vapor-permeable waterproof sheet (Tyvek® 1060B (DuPont-Asahi)) and then peeled off at each temperature of 0° C. and 60° C. at a peeling angle of 180° at a peeling speed of 300 mm/minute while the adhesion strength (N/25 mm width) was determined.

The adhesive layer (B) of the pressure-sensitive adhesive double-coated sheet with a width of 25 mm was attached to a wooden board (hemlock) and then peeled off at each temperature of 0° C. and 60° C. at a peeling angle of 180° at a peeling speed of 300 mm/minute while the adhesion strength (N/25 mm width) was determined.

Holding Power Test

The adhesive layer (B) of the pressure-sensitive adhesive double-coated sheet in a size of 25 mm×25 mm was attached to a stainless steel plate. The attached sheet was allowed to stand in the atmosphere at 60° C. for 5 minutes under a static load of 300 g perpendicularly applied to one end of the sheet, and then the distance (mm) shifted by the sheet was measured.

TABLE 1

| | | | | Adhesion Strength | | | | |
|---|---|---|---|---|---|---|---|---|
| | | | | (N/25 mm Width) | | | | |
| | Pressure-Sensitive | | | Adhesive Layer | | | | |
| | Adhesive Composition | | | (A) to Moisture | | | | |
| | Adhesive | Adhesive | Expansion | Vapor-Permeable | | Adhesive Layer (B) | | Holding |
| | Layer | Layer | Coefficient | Waterproof Sheet | | to Wooden Board | | Power |
| | (A) | (B) | (%) | 0° C. | 60° C. | 0° C. | 60° C. | (mm) |
| Example 1 | (a) | (b) | 0.4 | 10 | 7 | 18 | 8 | 1.5 |
| Example 2 | (a) | (b) | 0.4 | 10 | 8 | 18 | 8 | 1.5 |
| Example 3 | (a) | (c) | 0.4 | 11 | 7 | 10 | 7 | 5 |
| Example 4 | (a) | (a) | 0.4 | 10 | 7 | 8 | 10 | 0.5 |
| Example 5 | (a) | (d) | 0.4 | 10 | 7 | 17 | 5 | 10 |
| Comparative | (c) | (c) | 2.0 | 9 | 5 | 10 | 7 | 5 |
| Example 1 | | | | | | | | |
| Comparative | (a) | (c) | 1.5 | 10 | 8 | 10 | 7 | 5 |
| Example 2 | | | | | | | | |

Table 1 shows that the pressure-sensitive adhesive double-coated sheets of Examples 1 to 5 according to this invention provide lower expansion coefficient for the moisture vapor-permeable waterproof sheet and exhibit good adhesion of the adhesive layer (A) on the side of the moisture vapor-permeable waterproof sheet at low and high temperatures. Particularly, it is apparent that Examples 1 to 3, in which the adhesive layer (B) comprises the crosslinked pressure-sensitive adhesive composition, each shows good adhesion to the wooden board at low and high temperatures and good holding power with respect to the stainless steel. In contrast, Comparative Example 1, in which the pressure-sensitive adhesive composition of the adhesive layer (A) contains a low molecular-weight process oil, provided a high expansion coefficient and allowed the moisture vapor-permeable waterproof sheet to form ridges and grooves. The substrate of the pressure-sensitive adhesive double-coated sheet in Comparative Example 2 had an inappropriate composition so that the process oil shifted into the non-woven fabric of the substrate and the moisture vapor-permeable waterproof sheet wove to have a high expansion coefficient.

What is claimed is:

1. A pressure-sensitive adhesive double-coated sheet comprising a substrate, a pressure-sensitive adhesive layer (A) formed on one side of the substrate and a pressure-sensitive adhesive layer (B) formed on the other side of the substrate,
wherein at least the pressure-sensitive adhesive layer (A) is formed with a pressure-sensitive adhesive comprising a butyl rubber as base material,
and after the pressure-sensitive adhesive double-coated sheet is allowed to stand at 60° C. for five days while being placed between a moisture vapor-permeable waterproof sheet attached to the adhesive layer (A) and an aluminum plate attached to the adhesive layer (B), an expansion coefficient of the moisture vapor-permeable waterproof sheet is 0.5% or less.

2. A pressure-sensitive adhesive double-coated sheet comprising a substrate, a pressure-sensitive adhesive layer (A) formed on one side of the substrate and a pressure-sensitive adhesive layer (B) formed on the other side of the substrate,
wherein at least the pressure-sensitive adhesive layer (A) is formed with a pressure-sensitive adhesive comprising a butyl rubber as base material and a softener, which has a weight, average molecular weight of 1000 or more.

3. The pressure-sensitive adhesive double-coated sheet according to claim 1,
wherein the pressure-sensitive adhesive layer (B) comprises an adhesive crosslinked with a crosslinking agent.

4. The pressure-sensitive adhesive double-coated sheet according to claim 2,
wherein the pressure-sensitive adhesive layer (B) comprises an adhesive crosslinked with a crosslinking agent.

5. The pressure-sensitive adhesive double-coated sheet according to any one of claims 1 to 4,
wherein the substrate comprises at least one layer of plastic film.
